(19) United States
(12) Patent Application Publication
(10) Pub. No.: US 2011/0138120 A1
(43) Pub. Date: Jun. 9, 2011

(54) INFORMATION PROCESSOR, AND OPTICAL DISC DRIVE USED IN INFORMATION PROCESSOR

(76) Inventor: Atsushi FUCHIWAKI, Yokohama (JP)

(21) Appl. No.: 12/958,653

(22) Filed: Dec. 2, 2010

(30) Foreign Application Priority Data
Dec. 3, 2009 (JP) 2009-275668

(51) Int. Cl. G06F 12/08

(52) U.S. Cl. 711/113; 711/E12.019

(57) ABSTRACT

The speed of recording or reproduction of data to or from an HDD in an information processor is increased. This is achieved without an increase in device size, system changes, or other inconvenience. A cache memory configured by, for example, a flash memory for the data to be recorded to or reproduced from the HDD is provided not on the HDD side but on the ODD side. When, after the HDD has been replaced, there is inconvenience in using this cache memory as a cache for the data to be recorded, the cache memory is used only as a cache for the data to be reproduced, and if data in the cache memory and data on the HDD do not match each other, the cached data is invalidated.

### INCORPORATION BY REFERENCE

This application relates to and claims priority from Japanese Patent Application No. 2009-275668 filed on Dec. 3, 2009, the entire disclosure of which is incorporated herein by reference.

### BACKGROUND OF THE INVENTION

1. Field of the Invention

The present invention relates to an information processor, and an optical disc drive used in an information processor, in particular, an information processor that increases the speed of recording to or reproduction from a recording device, and an optical disc drive used in an information processor.

2. Description of the Related Art

Notebook PCs designed for mobile use have become widespread in the field of personal computers (PCs). At present, there are ongoing technological developments for downsizing and slimming down of notebook PCs. Typically, many notebook PCs come installed with a hard disk drive (HDD) using a hard disk, or an optical disc drive (ODD) using a removable optical disc, as an information recording device. For this reason, 2.5-inch or 1.8-inch compact hard disks are used for HDDs installed in notebook PCs, and thin disc drives called slim drives are used as ODDs.

Japanese Patent Application Laid-Open No. 2000-306048 discloses a mobile information reader that can record read information to a removable medium.

### SUMMARY OF THE INVENTION

For information processors such as notebook PCs for mobile use, there is a constant demand for not only downsizing and slimming down but also for increased speed of recording to or reproduction from a recording device. Of course, it is important to be able to achieve such speedup without hindering the above-mentioned downsizing and slimming down of HDDs or ODDs, and also without introducing major changes to system controls of information processors.

In view of the above-mentioned problems, it is an object of the present invention to provide an information processor that increases the speed of recording to or reproduction from a recording device, and an optical disc drive used in an information processor.

To address the above-mentioned problems, according to the present invention, there is provided an information processor for recording or reproducing information data, including a host device that controls overall operation of the information processor, an HDD that records or reproduces the information data to or from a hard disk recording medium built in the HDD in accordance with control from the host device, an ODD that records or reproduces the information data to or from an optical disc recording medium in accordance with control from the host device, and a cache memory that is built in the ODD, and caches the information data to be recorded to the hard disk recording medium when recording the information data to the hard disk recording medium.

Also, according to the present invention, there is provided an information processor for recording or reproducing information data, including a host device that controls overall operation of the information processor, an HDD that records or reproduces the information data to or from a hard disk recording medium built in the HDD in accordance with control from the host device, an ODD that records or reproduces the information data to or from an optical disc recording medium in accordance with control from the host device, and a cache memory that is built in the ODD, and caches the information data recorded on the hard disk recording medium when editing of the information data is finished.

Also, according to the present invention, there is provided an optical disc drive which is used in an information processor having a host device that controls an operation for recording or reproducing information data, an HDD that records or reproduces the information data to or from a hard disk recording medium built in the HDD in accordance with control from the host device, and an optical disc drive (ODD) that records or reproduces the information data to or from an optical disc recording medium in accordance with control from the host device, the optical disc drive including a cache memory that caches the information data to be recorded to the hard disk recording medium when recording the information data to the hard disk recording medium.

Also, according to the present invention, there is provided an optical disc drive which is used in an information processor having a host device that controls an operation for recording or reproducing information data, an HDD that records or reproduces the information data to or from a hard disk recording medium built in the HDD in accordance with control from the host device, and an optical disc drive (ODD) that records or reproduces the information data to or from an optical disc recording medium in accordance with control from the host device, the optical disc drive including a cache memory that caches the information recorded on the hard disk recording medium when editing of the information data is finished.

The present invention can provide an information processor that increases the speed of recording to or reproduction from a recording device, and an optical disc drive used in an information processor, thereby advantageously contributing to improved usability for the user.

### BRIEF DESCRIPTION OF THE DRAWINGS

These and other features, objects and advantages of the present invention will become more apparent from the following description when taken in conjunction with the accompanying drawings wherein:

FIG. 1 is a block diagram of an information processor according to an embodiment of the present invention;

FIG. 2 is a block diagram showing an example of information processor according to the related art; and

FIG. 3 is a block diagram showing another example of information processor according to the related art.

### DETAILED DESCRIPTION OF THE EMBODIMENT

A hard disk is the most common type of recording medium in today's PCs. Many pieces of application software and user-created files, including the operating system (OS), are stored on a HDD. Since an HDD records or reproduces information by rotating a disk-shaped recording medium, and moving a head used for recording or reproduction of information, large power consumption is required. Also, to record or reproduce non-serial information, the above-mentioned head needs to be moved, which leads to an increase in processing time. One way to achieve the above-mentioned speedup of recording or reproduction and lower power consumption is to adopt solid state drives (SSDs) installed with large-capacity flash memories that require no mechanism control to replace HDDs. However, despite the falling price of semiconductor memories, SSDs are still too expensive in terms of price per unit bit to completely replace HDDs with large capacity. Moreover, at present, the rewrite durability of SSDs when rewriting data repeatedly still does not match up to that of HDDs.

Accordingly, one characteristic feature of an embodiment of the present invention resides in providing a memory such as a flash memory which is smaller in capacity than an HDD, using this memory as a cache memory for the HDD, and further installing this cache memory in an ODD. This aims at increasing the speed of recording or reproduction of data on the HDD by use of the above-mentioned cache memory. Furthermore, this aims at achieving speedup of data recording or reproduction by a method that does not involve an increase in device size, significant changes to system controls, and an increase in price.

Hereinbelow, an embodiment of the present invention is described with reference to the drawings.

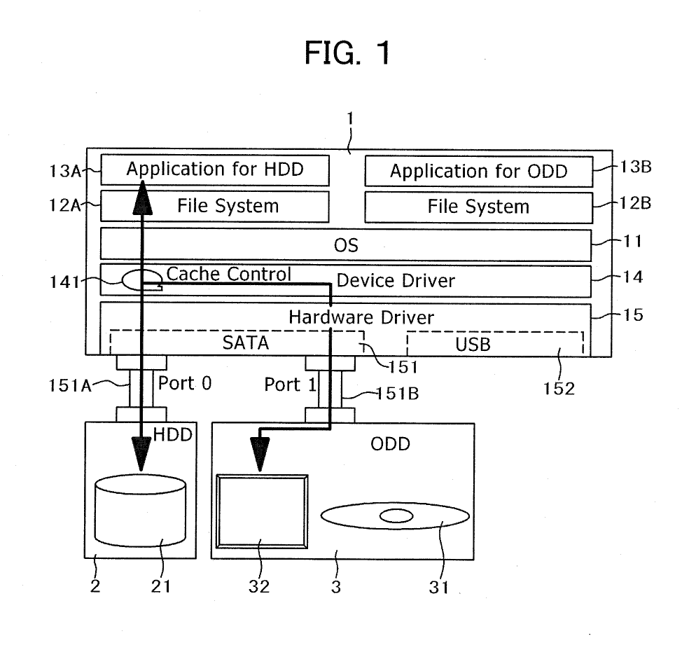

FIG. 1 is a block diagram of an information processor according to an embodiment of the present invention. The information processor according to this embodiment includes a host device 1, an HDD 2, and an ODD 3.

The host device 1 controls the entire information processor. Here, for the ease of explanation, rather than a configuration of hardware such as a CPU and a memory, a configuration of software is shown. Although these pieces of software are mainly stored on the HDD 2, when the host device 1 is active, these pieces of software are read as appropriate and stored onto a storage unit included in the host device 1 in accordance with the structure shown in FIG. 1.

The HDD 2 includes a hard disk 21 that is a recording medium. The ODD 3 includes a cache memory 32 configured by, for example, the flash memory mentioned above, and can include an optical disc 31 that can be removed for replacement. Illustration of hardware such as a CPU or a recording/reproduction processing circuit is omitted for the HDD 2 and the ODD 3 as well.

The host device 1 has an OS 11 as basic software for operation. The OS 11 controls individual pieces of software as other components. Symbol 12A denotes a first file system, which manages logical addresses on the recording device of data to be recorded to or reproduced from the HDD 2. Symbols 13A denote application software for the HDD 2, which controls recording to or reproduced from the HDD 2. Likewise, symbol 12B denotes a second file system, which manages logical addresses on the recording device of data to be recorded to or reproduced from an optical disc 31 included in the ODD 3. Symbol 13B denotes application software for the ODD 3, which controls recording to or reproduction from the optical disc 31 included in the ODD 3.

Symbol 14 denotes a device driver, which receives an instruction from the application software 13A, 13B or the file system 12A, 12B, and specifies the physical space to be used by data to be recorded to or reproduced from the HDD 2 or the ODD 3 in a format corresponding to each of the recording devices. Symbol 141 denotes a cache controller included in the device driver 14. The cache controller 141 performs a control for recording data to the HDD 2, or the cache memory 32 such as a flash memory included in the ODD 3 when recording the data in accordance with a command from the application software 13A for HDD, and also performs a control for sending data reproduced from the HDD 2 or the cache memory 32 to the application software 13A for HDD.

Symbol 15 denotes a hardware driver that provides standard-based interfacing between the HDD 2 and the ODD 3 in the host device 1, and an unillustrated external device. In the illustrated example, the hardware driver 15 has a SATA interface 151 based on the SATA (Serial Advanced Technology Attachment) standard for the HDD 2 and the ODD 3, and a USB interface 152 based on the USB (Universal Serial Bus) standard for an external added recording device or the like. The SATA interface 151 is connected to the HDD 2 via a cable 151A by using a predetermined port (Port 0 in the drawing), and is connected to the ODD 3 via a cable 151B by using a predetermined port (Port 1 in the drawing).

It should be noted that in FIG. 1, as the flow of data to be recorded and reproduced indicated by an arrow, only the flow of data when recording or reproducing data to or from the HDD 2 which concerns one characteristic feature of the present invention is shown, and the flow of data with respect to the optical disc 31 included in the ODD 3 is not shown.

As mentioned above, the characteristic feature of this embodiment resides in providing a memory configured as, for example, a flash memory in the ODD 3, and using this memory as the cache memory 32 for the HDD 2. This aims at increasing the speed of recording or reproduction of data to or from the HDD 2. To explain this in more detail, this embodiment is described below in comparison to other examples of information processor.

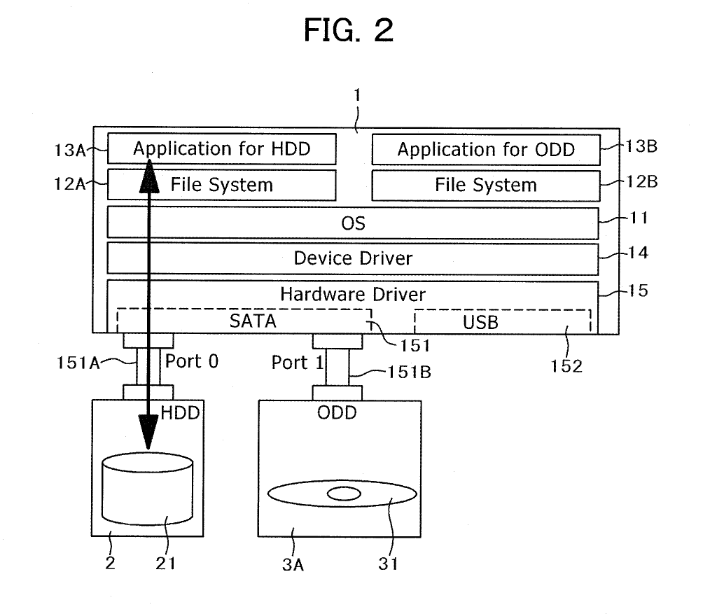

FIG. 2 is a block diagram showing an example of information processor according to the related art. In FIG. 2, components that may be the same as those in FIG. 1 are denoted by the same symbols, and description of such components is omitted. FIG. 2 shows an example of typical information processor according to the related art. As compared with FIG. 1, an ODD 3A does not have the cache memory as mentioned above, nor does the device driver 14 have the cache controller 141 mentioned above.

In comparison to FIG. 2, according to the above-mentioned embodiment shown in FIG. 1, the cache memory 32 for the HDD 2 is provided, thereby making it possible to increase the speed of recording or reproduction of data to or from the HDD 2.

Operation from a state where no data is accumulated in the cache memory 32 is described. For example, when there is a data reproduction request from the application software 13A for HDD of the host device 1, the corresponding data is read from the HDD 2 and sent to the host device 1, and this data is stored into the cache memory 32. Although data stored in the cache memory 32 may be frequently rewritten each time an overwrite (update) of each individual data is instructed from the host device 1 (write cache), as described later, when there is an overwrite instruction, registration into the cache memory 32 may be stopped, and the write may be made to the HDD 2 (read cache). Thereafter, when the application software 13A for HDD requests for data of the same file, the data stored in the cache memory 32 is immediately supplied, thereby enabling the speedup mentioned above. In contrast, the configuration shown in FIG. 2 requires a longer processing time corresponding to the time required for the HDD 2 to start operating.

Furthermore, electric current consumption can be advantageously reduced by reduced operation of the HDD 2. In FIG. 2, when reading data, the data always needs to be read from the HDD 2. However, in FIG. 1, there are significantly more occasions where data can be read from the cache memory 32. Accordingly, electric power consumption associated with reads can be reduced.

In FIG. 1, the above-mentioned advantages over FIG. 2 are attained by using the HDD 2 and the cache memory 32 in such a way that exploits their characteristic features. That is, while the HDD 2 has the benefit of being lower in price per unit bit in comparison to the cache memory 32 configured by, for example, a flash memory, the HDD 2 has the drawback of requiring a long processing time when recording or reproducing data, and hence large electric current consumption. Although totally replacing the HDD 2 with a flash memory of the same capacity to reduce processing time leads to a significant increase in price at present, by using a flash memory with such a small capacity that does not cause any particular problem in terms of price, the above-mentioned problems associated with processing time and price can be overcome, and furthermore a reduction in electric current consumption is achieved.

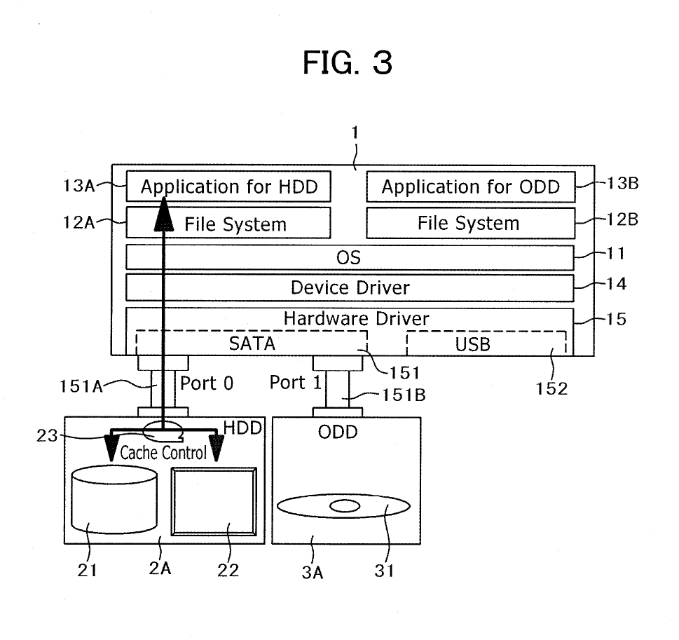

FIG. 3 is a block diagram showing yet another example of information processor according to the related art. As compared with FIG. 3, the configuration shown in FIG. 2 differs in that an HDD 2A has a cache memory 22 (which may be the same as the cache memory 32 in FIG. 1) and a cache controller 23 (which may be the same as the cache controller 141 in FIG. 1). That is, unlike both FIG. 1 and FIG. 2, the configuration shown in FIG. 3 aims at increasing the speed of recording to or reproduction from the HDD 2A by using the cache memory 22 included in the HDD 2A.

The above-mentioned embodiment shown in FIG. 1 has the following benefits in comparison to FIG. 3.

First, an interface to the HDD 2 of the host device 1, and an interface to the cache memory 32 are done independently in parallel via Port 0 and Port 1 in the drawing, respectively. In contrast, in FIG. 3, both the interfaces are done via Port 0 in the drawing. As is well known, while the information processor is running, access to the HDD 2 via Port 0 is made constantly by the host device 1. The configuration shown in FIG. 3 leads to an increase in the amount of such data to be exchanged via Port 0 in comparison to FIG. 1 and FIG. 2, and hence is not as effective as the configuration in FIG. 1 in increasing the speed of recording or reproduction.

As mentioned above, the HDD 2 operates frequently while the information processor 1 is running. In contrast, there are far fewer occasions when the ODD 3 operates to record to or reproduce from the optical disc 31. Therefore, even if Port 1 in the drawing is shared by the data on the optical disc 31 and the data in the cache memory 32 in FIG. 1, this hardly presents any hindrance to increasing the speed of recording or reproduction, and the anticipated speedup can be achieved.

Although the ODD 3 is becoming increasingly thinner, as compared with the HDD 2, the ODD 3 still leaves some space for placing a new component inside. For this reason, providing the cache memory 32 inside the ODD 3 in FIG. 1 does not hinder downsizing and slimming down of devices such as notebook PCs. These are also benefits as compared with the case of providing the cache memory 22 in the HDD 2A as shown in FIG. 3.

Furthermore, in FIG. 1, data to be exchanged via Port 0 may be the same as that in FIG. 2. In FIG. 3, since both data on the hard disk 21 and data in the cache memory 22 are exchanged via Port 0, it is necessary to make changes to the control software of the host device 1. It should be noted that in FIG. 1, both data on the optical disc 31 and data in the cache memory 32 are exchanged via Port 1. However, as mentioned above, there are far fewer times when the optical disc 31 operates in comparison to when the hard disk 21 operates. Hence, the above-mentioned problem is unlikely to occur.

The cache memory 32 shown in FIG. 1 may be shared for use as a cache memory when the ODD 3 records or reproduces data to or from the optical disc 31. In this case, the cache memory 32 can also contrite to increasing the speed of recording or reproduction of data to or from the optical disc 31.

Furthermore, the cache memory 32 can also double as a cache memory for the host device 1. That is, the cache memory 32 can function as a cache memory for one of the host device 1, the HDD 2, and the ODD 3, or for two or more of these devices. If the cache memory 32 is to double as a cache memory for a plurality of devices, the storage area of the cache memory 32 is preferably divided and managed in accordance with the number of the above-mentioned devices.

Further applications of this embodiment include a method in which the cache memory 32 operates as the read cache mentioned above as a cache memory used when reading data, and does not operate as the write cache mentioned above.

When write caching is done, data in the cache memory is frequently rewritten. As mentioned above, at present, the rewrite durability of flash memories does not match up to that of hard disks.

Furthermore, for fairly advanced users, there are times when such users dismount not only the optical disc 31 but also the HDD 2 to mount another HDD, or mount the dismounted HDD to another information processor for use. If the HDD 2 is dismounted when data to be recorded has been cached only in the cache memory 32 and has not been recorded on the HDD 2, there is a problem in that a predetermined recording operation cannot be completed.

To avoid such inconvenience, it is preferable to limit caching to read caching. Also, by comparing data in the cache memory 32 with data on the HDD 2 to verify their match, it is possible to learn whether or not replacement of the HDD as mentioned above has been done. In this case, if the two pieces of data do not match each other, the data in the cache memory 32 is preferably invalidated and not used.

The above-mentioned example that limits caching to read caching in this way takes note of the fact that instead of being slow in terms of processing, a hard disk has high durability for rewriting of data in comparison to a flash memory. That is, the above embodiment realizes an information processor that combines both the benefits of a hard disk and a flash memory in such a way that during operation involving frequent rewriting of data such as overwrite-updating of data, only data on the hard disk is rewritten, and data in the flash memory is also rewritten at the time when, for example, editing is finished, and during read operation of data, data in the flash memory is read to increase the speed of processing.

The embodiment that has been described so far is merely illustrative, and does not limit the present invention. For example, several modifications are conceivable for the host device 1. While other different embodiments are also conceivable within the scope of the present invention, the present invention encompasses all such embodiments.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. An information processor for recording or reproducing information data, comprising:
a host device that controls overall operation of the information processor;
an HDD that records or reproduces the information data to or from a hard disk recording medium built in the HDD in accordance with control from the host device;
an ODD that records or reproduces the information data to or from an optical disc recording medium in accordance with control from the host device; and
a cache memory that is built in the ODD, and caches the information data to be recorded to the hard disk recording medium when recording the information data to the hard disk recording medium.

2. The information processor according to claim 1, wherein the cache memory is shared for use as a cache memory for the optical disc recording medium.

3. An information processor for recording or reproducing information data, comprising:
a host device that controls overall operation of the information processor;
an HDD that records or reproduces the information data to or from a hard disk recording medium built in the HDD in accordance with control from the host device;
an ODD that records or reproduces the information data to or from an optical disc recording medium in accordance with control from the host device; and
a cache memory that is built in the ODD, and caches the information data recorded on the hard disk recording medium when editing of the information data is finished.

4. The information processor according to claim 3, wherein the cache memory is shared for use as a cache memory for the optical disc recording medium.

5. The information processor according to any one of claims 1 to 3, wherein when the information data recorded on the hard disk recording medium and the information data cached in the cache memory do not match each other, the information data cached in the cache memory is not used as cached data.

6. An optical disc drive which is used in an information processor having
a host device that controls an operation for recording or reproducing information data,
an HDD that records or reproduces the information data to or from a hard disk recording medium built in the HDD in accordance with control from the host device, and
an optical disc drive (ODD) that records or reproduces the information data to or from an optical disc recording medium in accordance with control from the host device, comprising:
a cache memory that caches the information data to be recorded to the hard disk recording medium when recording the information data to the hard disk recording medium.

7. An optical disc drive which is used in an information processor having
a host device that controls an operation for recording or reproducing information data,
an HDD that records or reproduces the information data to or from a hard disk recording medium built in the HDD in accordance with control from the host device, and
an optical disc drive (ODD) that records or reproduces the information data to or from an optical disc recording medium in accordance with control from the host device, comprising:
a cache memory that caches the information recorded on the hard disk recording medium when editing of the information data is finished.
